(19) United States
(12) Patent Application Publication
(10) Pub. No.: US 2011/0188030 A1
(43) Pub. Date: Aug. 4, 2011

(54) MICROELECTRONIC SENSOR DEVICE FOR OPTICAL EXAMINATIONS IN A SAMPLE MEDIUM

(75) Inventors: Coen Adrianus Verschuren, Eindhoven (NL); Menno Willem Jose Prins, Rosmalen (NL); Albert Hendrik Jan Immink, Eindhoven (NL)

(73) Assignee: KONINKLIJKE PHILIPS ELECTRONICS N.V., EINDHOVEN (NL)

(21) Appl. No.: 12/671,735

(22) PCT Filed: Jul. 17, 2008
(86) PCT No.: PCT/IB08/52870

§ 371 Date: Feb. 2, 2010

(30) Foreign Application Priority Data
Aug. 9, 2007 (EP) 07114101.4

(51) Int. Cl. G01N 21/41

(52) U.S. Cl. 356/128

(57) ABSTRACT

The invention relates to a microelectronic sensor device with a light source (21) for emitting an input light beam (L1) into a transparent carrier (11) such that it is totally internally reflected at a contact surface (12) as an output light beam (L2), which is detected by a light detector (31). Frustration of the total internal reflection at the contact surface (12) can then for example be used to determine the amount of target particles (1) present at this surface. The sensor device further comprises a refractive index measurement unit (100, 200, 300) for measuring the refractive index (n_{B}) of the sample medium, and an evaluation unit (50) for evaluating the measurement of the light detector (31) taking the measured refractive index (n_{B}) into account and/or for changing the conditions of total internal reflection of the input light beam (L1). The refractive index measurement unit may particularly be designed to infer the refractive index (n_{B}) from the deflection of a test-light beam (L3) that is transmitted through the sample medium, or from a reflection of a test-light beam (L1) at an interface (12) to the sample medium. In the latter case, it is possible to determine the critical angle of total internal reflection and/or to measure the reflectivity of the interface.

The invention relates to a microelectronic sensor device and a method for optical examinations in a sample medium adjacent to the contact surface of a carrier, wherein the examinations comprise the total internal reflection of an input light beam. Moreover, it relates to the use of such device.

The US 2005/0048599 A1 discloses a method for the investigation of microorganisms that are tagged with particles such that a (e.g. magnetic) force can be exerted on them. In one embodiment of this method, a light beam is directed through a transparent material to a surface where it is totally internally reflected. Light of this beam that leaves the transparent material as an evanescent wave is scattered by microorganisms and/or other components at the surface and then detected by a photodetector or used to illuminate the microorganisms for visual observation. A problem of this and similar setups is that the optical effects depend on the refractive index of the sample medium, which may vary from charge to charge. This may severely deteriorate the accuracy of quantitative measurements.

Based on this situation it was an object of the present invention to provide alternative means for making optical examinations with a sample medium that are based on total internal reflection (TIR), wherein it is desirable that the examinations can be made with a high accuracy and robustness with respect to different sample media.

This object is achieved by a microelectronic sensor device according to claim 1, a method according to claim 10, and a use according to claim 15. Preferred embodiments are disclosed in the dependent claims.

The microelectronic sensor device according to the present invention serves for making optical examinations in a sample medium (e.g. blood or saliva) that is provided adjacent to the contact surface of a carrier (wherein the carrier does not necessarily belong to the device). In this context, the term “examination” is to be understood in a broad sense, comprising any kind of manipulation and/or interaction of light with some entity in the sample medium. The examinations may preferably comprise the qualitative or quantitative detection of target components comprising label particles, wherein the target components may for example be biological substances like biomolecules, complexes, cell fractions or cells. The carrier will usually be made from a transparent material, for example glass or poly-styrene, to allow the propagation of light of a given (particularly visible, UV, and/or IR) spectrum. The term “contact surface” is chosen primarily as a unique reference to a particular part of the surface of the carrier, and though target components will in many applications actually contact and bind to said surface, this does not necessarily need to be the case.

The microelectronic sensor device comprises the following components:
a) A light source for emitting a light beam, called “input light beam” in the following, into the carrier such that it is totally internally reflected at the contact surface of the carrier. The light source may for example be a laser or a light emitting diode (LED), optionally provided with some optics for shaping and directing the input light beam. Moreover, it should be noted that the occurrence of total internal reflection requires that the refractive index of the carrier is larger than the refractive index of the sample medium adjacent to the contact surface. This is for example the case if the carrier is made from glass (n=1.6-2) and the sample medium is water (n=1.3). It should further be noted that the term “total internal reflection” shall include the case called “frustrated total internal reflection”, where some of the incident light is lost (absorbed, scattered etc.) during the reflection process.
b) A light detector for measuring a characteristic parameter of the aforementioned output light beam that comes (directly or indirectly) from the contact surface of the carrier. The characteristic parameter may particularly comprise the amount of light in the output light beam, e.g. expressed as the intensity of this beam in its cross section. The detector may comprise any suitable sensor or plurality of sensors by which light of a given spectrum can be detected, for example photodiodes, photo resistors, photocells, a CCD chip, or a photo multiplier tube.
c) A refractive index measurement unit, which will be abbreviated “RIMU” in the following, for measuring the refractive index of the sample medium that is provided adjacent to the contact surface. Several particular realizations of this RIMU will be described in more detail with reference to preferred embodiments of the invention. The measurement of the RIMU may result in a signal that explicitly or implicitly represents the refractive index.
d) An evaluation unit for evaluating the measured characteristic parameter of the output light beam, wherein the measured refractive index of the sample medium is taken into account during this evaluation, and/or for changing the conditions of total internal reflection (TIR) of the input light beam at the contact surface of the carrier according to the measured refractive index. The evaluation unit may be realized by dedicated (analog) electronic hardware, by digital data processing circuits with appropriate software, or by a mixture of both.

The described microelectronic sensor device allows for optical examinations of a sample medium with the help of a total internal reflection at the contact surface to this medium. At the same time, the device provides an independent measurement of the refractive index of the sample medium. This refractive index usually affects significantly the optical processes that are associated to the total internal reflection; taking the independently measured refractive index into account can therefore make the outcome of such processes more robust with respect to variations in the refractive index of the sample medium. The same advantage is achieved if the conditions of TIR are changed based on the measured refractive index. This change can for example compensate the effect of a variation of the refractive index on desired optical processes.

In general, there are many possibilities how the evaluation unit can take the measured refractive index into account. In a practically important example, the evaluation process that is executed by the evaluation unit may be based on a (direct or indirect) estimation of the decay distance of evanescent waves that are generated during the total internal reflection of the input light beam at the contact surface. This approach is based on the fact that many TIR-related optical examinations make use of evanescent waves to exactly localize processes in a small volume adjacent to the TIR-interface, wherein the size of this volume is crucially dependent on the decay distance of the evanescent waves, which in turn depends on the refractive index of the sample medium.

In a typical application of the microelectronic sensor device, the evaluation unit is adapted to determine the amount of target particles—e.g. atoms, ions, (bio-)molecules, cells, viruses, or fractions of cells or viruses, tissue extract, etc., including labels like magnetic, fluorescent, or radioactive particles—that are present in the sample medium at the contact surface of the carrier. This amount can particularly be determined due to the effect that such target particles scatter light of the evanescent waves which are generated during the total internal reflection of the input light beam, thus leading to a so-called frustrated total internal reflection (FTIR). The degree of frustration will then provide information about the amount of target particles at the contact surface. The amount of detected target particles at the contact surface may have a direct (and known) relation to the amount of target particles present in the sample fluid. In case the target particles are labels for other components, e.g. certain biomolecules, their amount is further related to the amount of these components.

It was already mentioned that there is a variety of possibilities to realized the refractive index measurement unit (RIMU). In a first realization, the RIMU comprises the following components:
a) A test-light source for transmitting a test-light beam through two transparent walls and a test chamber that lies intermediately between said walls and in which the sample medium can be provided. The test-light source may for example be a laser or a light emitting diode (LED), optionally provided with some optics for shaping and directing the test-light beam. The transparent walls may particularly be made of the same material as the carrier.
b) A test-light detector for detecting the spatial position of the transmitted test-light beam. The test-light detector may comprise any suitable sensor or plurality of sensors by which light of a given spectrum can be detected, for example photodiodes, photo resistors, photocells, a CCD chip, or a photo multiplier tube.
c) And, optionally, an estimation module for estimating the refractive index of a sample medium in the sample chamber from the detected spatial position of the transmitted test-light beam. The estimation module may be realized by dedicated electronic hardware and/or digital data processing circuits with appropriate software. It may particularly comprise a memory in which the relation between spatial positions and refractive indices is stored, e.g. as a look-up table. The estimation module is only optional because the measurements of the test-light detector may alternatively be processed as raw data by the evaluation unit.

As will be explained in more detail with reference to the Figures, the described RIMU exploits the fact that the optical path of a (test-) light beam will experience deflections when it passes (oblique) through an interface between two media of different refractive indices. Thus the spatial position of the transmitted test-light beam allows to infer the refractive index of the sample medium. It should be noted that the test-light source and/or the test-light detector may be realized by the light source and/or the light detector, respectively, of the microelectronic sensor device, or that they may alternatively be separate components. Moreover, the estimation module may at least partially be integrated into the evaluation unit of the microelectronic sensor device.

The mentioned test-light detector may comprise a single light-sensitive sensor unit and a scanning mechanism to find the spatial position of the transmitted test-light beam by moving said sensor unit through a search region. In an alternative embodiment, the test-light detector comprises a plurality of sensor units, which may be realized for example by the pixels of a charge coupled device (CCD) or a CMOS chip. This embodiment has the advantage that the test-light detector can remain at a fixed position in space and that the spatial position of the transmitted test-light beam can be inferred from the particular sensor unit(s) it impinges on, or, more generally, from the light distribution over the sensor units. In a similar embodiment, e.g. a split photodiode can be used, consisting of at least two, preferably closely spaced and identical detector parts. When the beam diameter in the detector plane is comparable to the lateral dimension of the detector parts, the beam position on the detector can be inferred from the ratio of the signals from the respective detector parts.

The transparent walls and the intermediate test chamber may in principle have an arbitrary design as long as they allow the transmission of the test-light beam in such a way that the spatial position of the transmitted beam depends on the refractive index of the medium in the test chamber. In a preferred embodiment, the two transparent walls have parallel sides, i.e. all four front- and backsides of the walls are parallel to each other. In this case a test-light beam that is transmitted through the walls at an oblique angle will be displaced in a parallel way depending on the refractive index of the sample medium between the walls.

While it is in principle possible that the RIMU with the two transparent walls and the test chamber is a separate entity independent of the carrier, it is a preferred embodiment of the invention that the two transparent walls belong to the carrier. Thus it can be guaranteed that the test chamber between the two walls is automatically filled with the same sample medium that is present adjacent to the contact surface. In this context it should be noted that the invention also refers to a particular carrier design comprising two such transparent walls with an intermediate test chamber between them.

Other approaches for measuring the refractive index of a sample medium are based on the reflection of a test-light beam. Thus another type of refractive index measurement unit (RIMU) may comprise the following components:
a) A test-light source for emitting a test-light beam under a known angle of incidence onto an at least partially reflective test surface which can be contacted by the sample medium, wherein said test-light beam is reflected from the test surface. The test-light source may for example be a laser or a light emitting diode (LED), optionally provided with some optics for shaping and directing the input light beam.
b) A test-light detector for determining the amount of light in the test-light beam after its reflection at the test surface. The test-light detector may comprise any suitable sensor or plurality of sensors by which light of a given spectrum can be detected, for example photodiodes, photo resistors, photocells, a CCD chip, or a photo multiplier tube. The amount of light may for example be expressed as the intensity of the beam in its cross section.
c) And, optionally, an estimation module for estimating the refractive index of the sample medium adjacent to the test surface from the determined amount of light in the reflected test-light beam. The estimation module may be realized by dedicated electronic hardware and/or digital data processing circuits with appropriate software. It may optionally be integrated into the evaluation module of the microelectronic sensor device. The estimation module is only optional because the measurements of the test-light detector may alternatively be processed as raw data by the evaluation unit.

The described RIMU exploits the fact that the reflection of a (test-) light beam at an interface to the sample medium depends on the refractive index of said sample medium. A particular advantage of this approach is that the necessary optical instruments (test-light source, test-light detector) can be arranged on the same side of the sample medium. Moreover, the reflection-based test requires no extensive light propagation within the sample medium and can therefore be executed with minimal amounts of a sample. Finally, it should be noted that the test-light source and/or the test-light detector can be identical to the light source and/or the light detector of the microelectronic sensor device, possibly with some necessary adaptations.

In a first particular realization of the aforementioned reflection-based approach, the estimation module is adapted to determine the critical angle of total internal reflection (TIR) at the test surface. As this critical angle depends on the refractive index of the sample medium that contacts the test surface, it is possible to infer the refractive index of a particular sample medium from the measured critical angle of TIR.

The aforementioned RIMU may particularly comprise a scanning unit for varying the angle of incidence of the test-light beam over a predetermined range, wherein this range preferably covers the (expected) critical angle of TIR. Thus the angle of incidence can be swept over a range of angles, and the critical angle of TIR can be found from the observed amount of light in the reflected light beam.

In another embodiment, the RIMU may comprise an optical system for directing simultaneously a plurality of test-light beams under different angles of incidence onto the test surface. In this case a range of angles of incidence can be examined in parallel.

According to still another embodiment, the RIMU may comprise an optical system for directing reflected test-light beams of different angles of incidence to the test-light detector. The test-light detector can then remain at a fixed position in space, which simplifies the mechanical design of the apparatus.

In a second particular realization of the reflection-based approach, the estimation module of the RIMU is adapted to determine the reflectivity of the test surface provided that the test-light beam has an angle of incidence smaller than the critical angle of TIR. This realization is based on the fact that the reflectivity depends (for angles of incidence smaller than the critical angle of TIR) on the refraction index of the sample medium that is adjacent to the test surface. The relation between the refractive index of a sample medium and the reflectivity can for example be determined for given angles of incidence from experiments. It can then be stored in a look-up table that can be used by the estimation module. An advantage of this design is that the hardware requirements are minimal, as a measurement at one given angle of incidence suffices.

It should further be noted that the transmission based approach and at least one of the reflection based approaches (with TIR-angle or reflectivity determination) can be applied in parallel to increase the accuracy and reliability of the determined results.

The invention further relates to a method for optical examinations in a sample medium adjacent to the contact surface of a carrier, comprising the following steps:
a) Emitting an input light beam into the carrier such that it is totally internally reflected as an output light beam at the contact surface.
b) Measuring a characteristic parameter of the output light beam.
c) Measuring the refractive index of the sample medium.
d) Evaluating the measured characteristic parameter taking the measured refractive index into account and/or changing the conditions of total internal reflection of the input light beam according to the measured refractive index.

The method comprises in general form the steps that can be executed with a microelectronic sensor device of the kind described above. Therefore, reference is made to the preceding description for more information on the details, advantages and improvements of that method.

In a first preferred embodiment of the method, a test-light beam is transmitted at an oblique angle through a test volume of the sample medium, and the displacement of this test-light beam after its transmission is measured.

In another embodiment of the method, the critical angle of total internal reflection between the sample medium and a test material is determined. The test material may in particular be the same material as that of the carrier.

Moreover, it is possible to measure for a given angle of incidence (smaller than the critical angle of TIR) the reflectivity of a test interface with the sample medium on one side.

The invention further relates to the use of the microelectronic device described above for molecular diagnostics, biological sample analysis, or chemical sample analysis, food analysis, and/or forensic analysis. Molecular diagnostics may for example be accomplished with the help of magnetic beads or fluorescent particles that are directly or indirectly attached to target molecules.

These and other aspects of the invention will be apparent from and elucidated with reference to the embodiment(s) described hereinafter. These embodiments will be described by way of example with the help of the accompanying drawings in which:

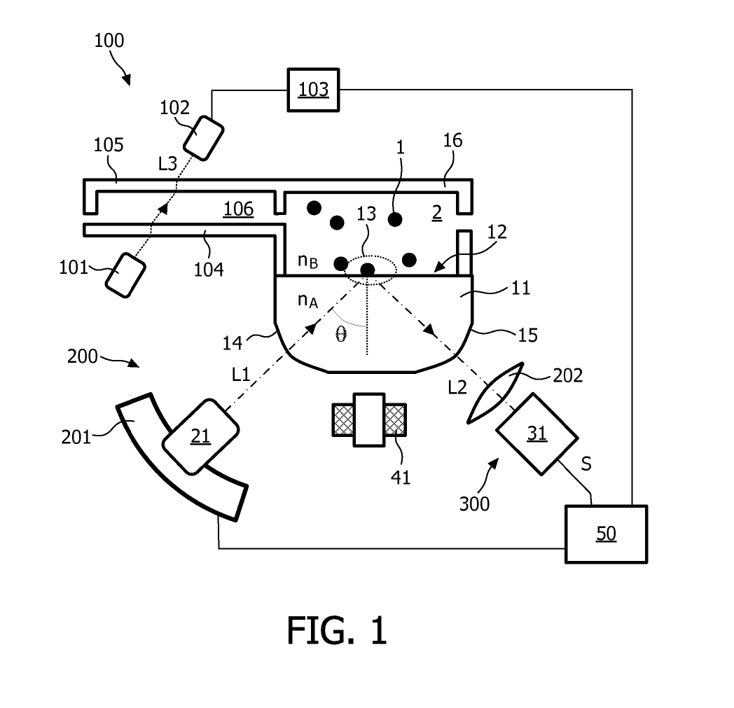

FIG. 1 shows schematically a microelectronic sensor device according to the present invention with three different RIMUs for measuring the refractive index of a sample medium;

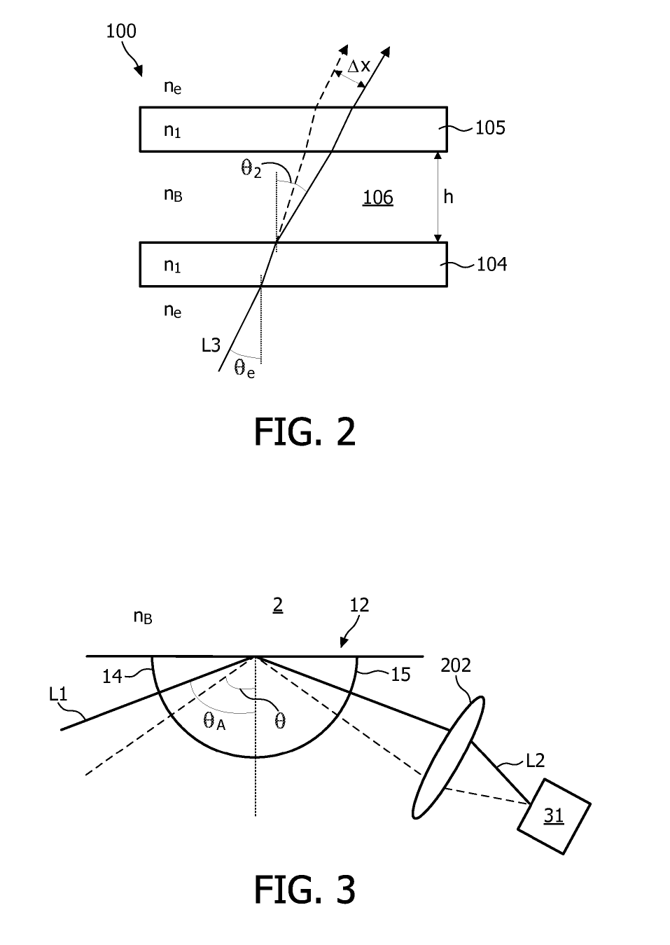

FIG. 2 shows in more detail the principle of measuring a deflection of a transmitted test-light beam;

FIG. 3 shows in more detail the principle of measuring the critical angle of TIR with a scanning mechanism;

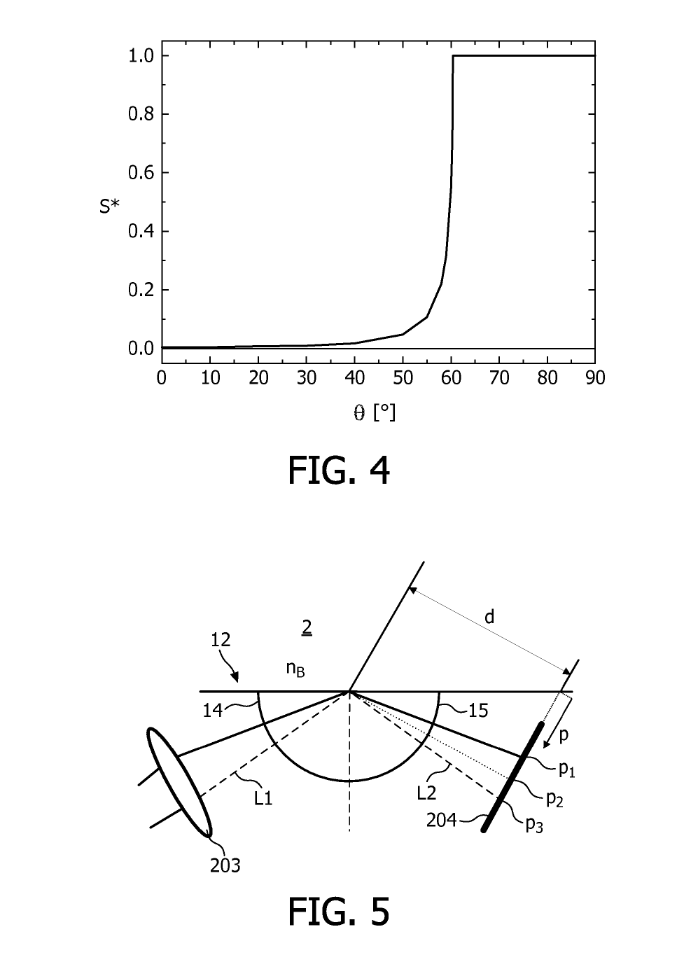

FIG. 4 shows the amount of light measured with a microelectronic sensor device like that of FIG. 3 in dependence on the angle of incidence;

FIG. 5 shows an alternative measurement design for the critical angle of TIR, in which a plurality of angles of incidence are tested simultaneously and measured with a pixelated detector;

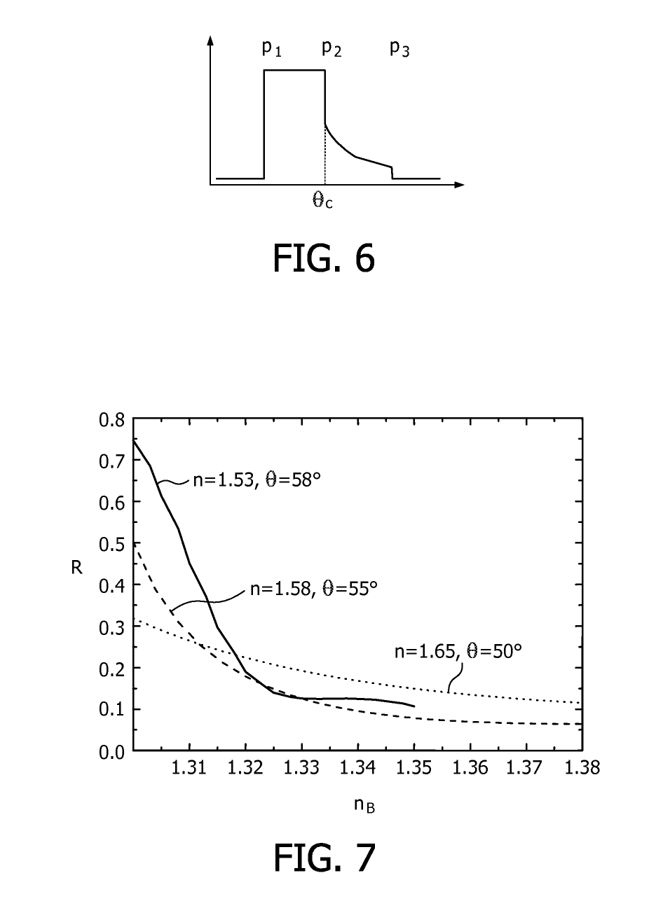

FIG. 6 illustrates the spatial responses measured with the detector of FIG. 5;

FIG. 7 shows in a diagram the dependence of the reflectivity on the refractive index of the sample medium adjacent to the reflecting interface;

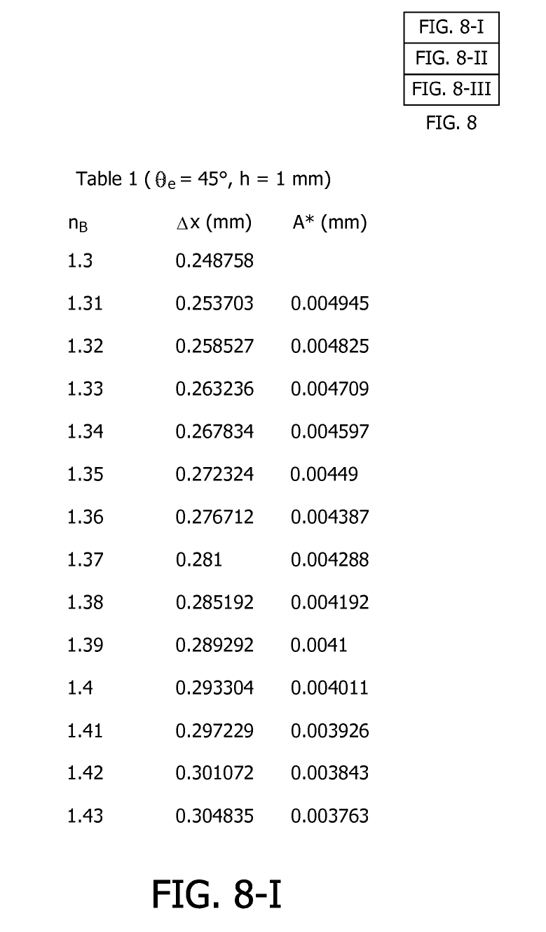

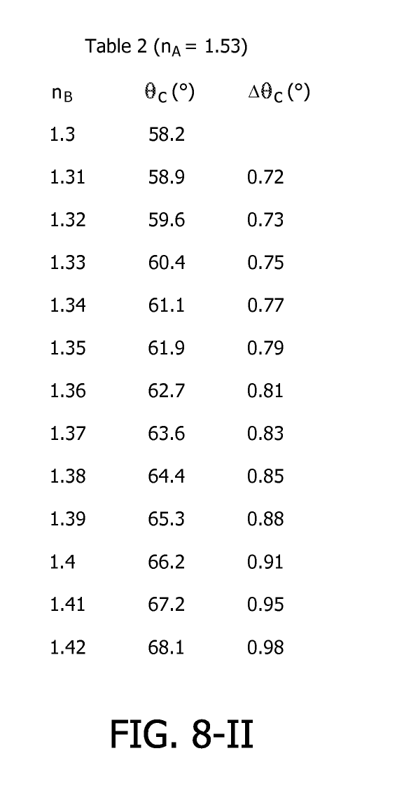

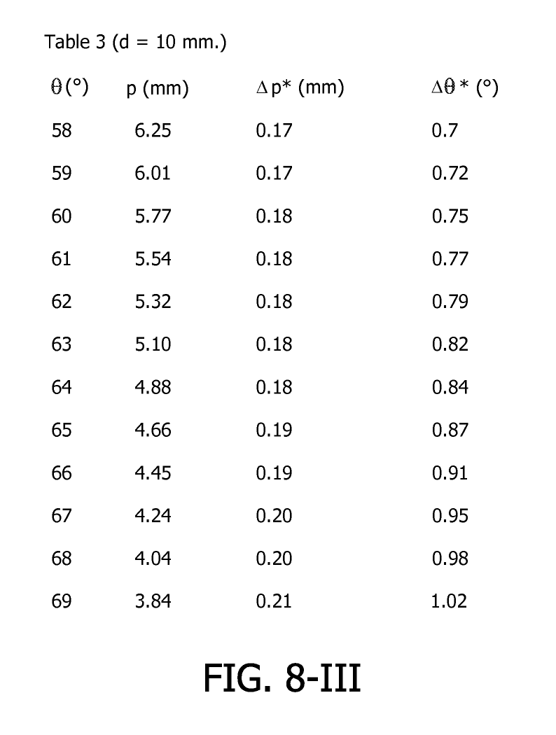

FIG. 8 comprises tables with various measured or calculated relations.

Like reference numbers or numbers differing by integer multiples of 100 refer in the Figures to identical or similar components.

Though the present invention will in the following be described with respect to a particular setup (using magnetic particles and frustrated total internal reflection as measurement principle), it is not limited to such an approach and can favorably be used in many different applications.

FIG. 1 shows a general setup with a microelectronic sensor device according to the present invention. A central component of this setup is the carrier 11 that may for example be made from glass or transparent plastic like poly-styrene. The carrier 11 is located next to a sample chamber 2 in which a sample fluid with target components to be detected (e.g. drugs, antibodies, DNA, etc.) can be provided. The sample further comprises magnetic particles, for example superparamagnetic beads, wherein these particles are usually bound as labels to the aforementioned target components. For simplicity only the combination of target components and magnetic particles is shown in the Figure and will be called “target particle” 1 in the following. It should be noted that instead of magnetic particles other label particles, for example electrically charged or fluorescent particles, could be used as well.

The interface between the carrier 11 and the sample chamber 2 is formed by a surface called “contact surface” 12. This contact surface 12 is coated with capture elements, e.g. antibodies, which can specifically bind the target particles.

The sensor device comprises a magnetic field generator 41, for example an electromagnet with a coil and a core, for controllably generating a magnetic field at the contact surface 12 and in the adjacent space of the sample chamber 2. With the help of this magnetic field, the target particles 1 can be manipulated, i.e. be magnetized and particularly be moved (if magnetic fields with gradients are used). Thus it is for example possible to attract target particles 1 to the contact surface 12 in order to accelerate their binding to said surface, or to wash unbound target particles away from the contact surface before a measurement.

The sensor device further comprises a light source 21 that generates an input light beam L1 which is transmitted into the carrier 11 through an “entrance window” 14. As light source 21, a laser or an LED, particularly a commercial DVD (λ=658 nm) laser-diode can be used. A collimator lens may be used to make the input light beam L1 parallel, and a pinhole of e.g. 0.5 mm may be used to reduce the beam diameter. The input light beam L1 arrives at the contact surface 12 at an angle θ=θ_{A} larger than the critical angle θ_{c} of total internal reflection (TIR) and is therefore totally internally reflected in an “output light beam” L2. The output light beam L2 leaves the carrier 11 through another surface (“exit window” 16) and is detected by a light detector 31. The light detector 31 determines the amount of light of the output light beam L2 (e.g. expressed by the light intensity of this light beam in the whole spectrum or a certain part of the spectrum). The measured sensor signals S are evaluated and optionally monitored over an observation period by an evaluation and recording module 50 that is coupled to the detector 31.

It is possible to use the detector 31 also for the sampling of fluorescence light emitted by fluorescent particles 1 which were stimulated by the input light beam L1, wherein this fluorescence may for example spectrally be discriminated from reflected light L2. Though the following description concentrates on the measurement of reflected light, the principles discussed here can mutatis mutandis be applied to the detection of fluorescence, too.

The described microelectronic sensor device applies optical means for the detection of target particles 1. For eliminating or at least minimizing the influence of background (e.g. of the sample fluid, such as saliva, blood, etc.), the detection technique should be surface-specific. As indicated above, this is achieved by using the principle of frustrated total internal reflection (FTIR). This principle is based on the fact that an evanescent wave propagates (exponentially dropping) into the sample 2 when the incident light beam L1 is totally internally reflected. If this evanescent wave then interacts with another medium like the bound target particles 1, part of the input light will be coupled into the sample fluid (this is called “frustrated total internal reflection”), and the reflected intensity will be reduced (while the reflected intensity will be 100% for a clean interface and no interaction). Depending on the amount of disturbance, i.e. the amount of target particles on or very near (within about 200 nm) to the TIR surface (not in the rest of the sample chamber 2), the reflected intensity will drop accordingly. This intensity drop is a direct measure for the amount of bound target particles 1, and therefore for the concentration of target particles in the sample. When the mentioned interaction distance of the evanescent wave of about 200 nm is compared with the typical dimensions of anti-bodies, target molecules and magnetic beads, it is clear that the influence of the background will be minimal. Larger wavelengths λ will increase the interaction distance, but the influence of the background liquid will still be very small.

The described procedure is independent of applied magnetic fields. This allows real-time optical monitoring of preparation, measurement and washing steps. The monitored signals can also be used to control the measurement or the individual process steps.

For the materials of a typical application, medium A of the carrier 11 can be glass and/or some transparent plastic with a typical refractive index of 1.52. Medium B in the sample chamber 2 will be water-based and have a refractive index close to 1.3. This corresponds to a critical angle θ_{c} of 60°. An angle of incidence of 70° is therefore a practical choice to allow fluid medium with a somewhat larger refractive index (assuming n_{A}=1.52, n_{B} is allowed up to a maximum of 1.43). Higher values of n_{B} would require a larger n_{A} and/or larger angles of incidence.

Advantages of the described optical read-out combined with magnetic labels for actuation are the following:
Cheap cartridge: The carrier 11 can consist of a relatively simple, injection-molded piece of polymer material.
Large multiplexing possibilities for multi-analyte testing: The contact surface 12 in a disposable cartridge can be optically scanned over a large area. Alternatively, large-area imaging is possible allowing a large detection array. Such an array (located on an optical transparent surface) can be made by e.g. ink-jet printing of different binding molecules on the optical surface. The method also enables high-throughput testing in well-plates by using multiple beams and multiple detectors and multiple actuation magnets (either mechanically moved or electro-magnetically actuated).
Actuation and sensing are orthogonal: Magnetic actuation of the target particles (by large magnetic fields and magnetic field gradients) does not influence the sensing process. The optical method therefore allows a continuous monitoring of the signal during actuation. This provides a lot of insights into the assay process and it allows easy kinetic detection methods based on signal slopes.
The system is really surface sensitive due to the exponentially decreasing evanescent field.
Easy interface: No electric interconnect between cartridge and reader is necessary. An optical window is the only requirement to probe the cartridge. A contact-less read-out can therefore be performed.
Low-noise read-out is possible.

In the described optical biosensor the refractive index n_{B} of the unknown sample liquid has an influence on the sensor signal S, i.e. the signal per target particle 1. For accurate, quantitative measurements with low coefficient of variation CV this may be a problem (note: The CV is reported as a percentage and calculated from the average or mean and standard deviation as follows: 100*Standard Deviation/Average). For example, the evanescent decay distance z (and thus the strength of the interaction with the target particles) depends on the ratio of refractive indices of carrier material and the sample liquid according to:

$$z = \frac{1}{k \sqrt{{n}_{A}^{2} {sin}^{2} ( {θ}_{A} ) - {n}_{B}^{2}}}$$

with k=2π/λ being the wavenumber of the input light beam, n_{A} and n_{B} the indices of refraction of carrier material and sample liquid, respectively, and θ_{A} the angle of incidence of the input light beam L1. Moreover, the amount of scattering depends on the refractive index difference between the sample liquid and the target particles 1.

To address this problem it is therefore proposed here to accurately measure the refractive index n_{B} of the sample liquid. The measurement can then be used to correct the sensor signal for differences in the refractive index, leading to a more accurate, quantitative measurement with low CV.

There are several methods to determine a refractive index. Three attractive methods are particularly suitable for practical implementation in a biosensor device: The first is based on a determination of the displacement of a refracted beam (incident at an angle below the critical angle of TIR) after transmission through the liquid. In the second method, the critical angle is determined from a reflected light beam. A third method involves a reflection measurement at a fixed, incident angle below the critical angle. These methods will below be described in more detail. The correction of the sensor signal S may be done “virtually” in a separate calculating element, embedded in hardware or in software code (or by some other means), or “physically” by adapting the evanescent decay length for example by changing the incident angle of the input light beam L1.

In FIG. 1, the three mentioned methods are applied in parallel for illustration purposes. The first, transmission-based method applies a reflective index measurement unit 100, called RIMU in the following, which comprises:
A test-light source 101 for emitting a test-light beam L3 under an oblique angle into a transparent wall 104.
A test chamber 106 that is formed between the aforementioned transparent wall 104 and a second, upper transparent wall 105, wherein said two walls are planar and parallel to each other. Moreover, the walls 104 and 105 in the shown embodiment are parts of a cover 16 that is placed on top of the carrier 11 and that forms together with the carrier 11 a disposable cartridge. The test chamber 106 may for example be located in a fluidic channel leading to the sample chamber 2. It may however also be located somewhere else, for example in a sub-region of the sample chamber 2, or it might alternatively be located in a completely separate device.
A test-light detector 102 for detecting the spatial position of the test-light beam L3 after its transmission through the walls 104 and 105 and the test chamber 106.
An estimation module 103 that is coupled to the test-light detector 102 for evaluating its measurements, i.e. for estimating the refractive index n_{B} of the sample medium in the test chamber 106 from the measured spatial position of the transmitted test-light beam L3. The output of the estimation module 103 is communicated to the evaluation module 50, where it can be used for correcting the TIR measurement signal S.

FIG. 2 illustrates the RIMU 100 in more detail. The principle used here is to detect a difference in refraction of light inside a test section of the cartridge. Obviously, the test section should be transparent for the test-light used (at least) at the location(s) where the test-light beam L3 is transmitted. A test-light beam L3 entering the cartridge from the outside (with known refractive index nₑ, typically nₑ=1 for air) through the bottom wall 104 at an oblique angle θₑ will be refracted in the cartridge material (with known refractive index n₁, typically 1.55), and again be refracted when entering the test chamber 106 inside the cartridge (with refractive index n_{B}, to be determined) to an angle θ₂, etc., until the test-light beam exits the top wall 105 of the cartridge. Depending on the sample material inside the cartridge, i.e. n_{B}, the test-light beam L3 will be displaced by some amount Δx. Even when the injected sample liquid is dispersive and/or absorbing, the beam displacement Δx still correctly indicates the refractive index n_{B} of the sample liquid. The solid lines in FIG. 2 illustrate the case for an empty cartridge (air, n_{B}=1). The dashed lines show that for larger values of n_{B}, the test-light beam L3 will refract towards the normal, leading to a displacement Δx with respect to the original beam. This beam displacement Δx is determined by a combination of n_{B}, θ_{c} and the height h of the test chamber 106, as can be derived using Snell's law of refraction, nₑ·sin θₑ=n_{B}·sin θ₂, and some simple geometry, resulting in

Δx=cos θₑ·(tan θₑ−tan θ₂)/h,

with θ₂=arcsin(sin θₑ/n_{B}). This displacement can be detected using a position sensitive test-light detector 102 or e.g. a pixelated detector such as a CCD. Alternatively, a scanning detector e.g. with a pinhole can be used to determine Δx.

To give an indication of the beam displacements, Table 1 of FIG. 8 gives an overview for θₑ=45°, various values of n_{B}, and h=1 mm. Since Δx scales with h, the effect of other cartridge heights is easily found. The third column of the Table shows the difference A* between consecutive entries of Δx. These numbers illustrate that in order to detect a difference in refractive index of 0.01, the beam displacement measurement should be as accurate as about 4 μm for a cartridge height of 1 mm (state of art CCD sensors have pixel pitches in the order of 1 μm and are therefore suitable for this method). It should be noted that larger angles give larger displacements, making the detection more robust. However, the test-light beam should remain in the test chamber.

Returning to FIG. 1, a second refractive index measurement unit RIMU 200 is illustrated which is based on the reflection of a test-light beam. More specifically, it is based on the determination of the critical angle of TIR, i.e. the transition angle from partial reflection and refraction to total internal reflection TIR, and only needs minor modifications of the optical biosensor based on FTIR. Moreover, this method is very sensitive and therefore preferred. The RIMU 200 of the embodiment shown in FIG. 1 comprises the following components:
A test-light source for emitting a test-light beam into the carrier 11. In the embodiment of FIG. 1, the test-light source is identical to the light source 21 discussed above, and the test-light beam is in principle identical to the input light beam L1. In the general case, these components may however be different.
A scanning unit 201 to which the test-light source 21 is attached such that it can be rotated in such a way that the test-light beam L1 can impinge onto the contact surface 12 under different angles θ of incidence.
An entrance window 14 through which the test-light beam L1 enters the carrier 11, wherein this entrance window 14 is curved with the centre of curvature lying in the investigation region 13 on the contact surface 12 where the test-light beams L1 impinge.
An exit window 15 through which the reflected test-light beam (in principle identical to the output light beam L2 discussed above) can leave the carrier 11. The exit window 15 is also curved with the centre of curvature lying in the investigation region 13.
An optical system, illustrated by a single lens 202, by which output light beams L2 that leave the carrier 11 under different angles are focused to a test-light detector. Again, the test-light detector is identical in this embodiment to the light detector 31 discussed above.

The RIMU 200 further comprises a particular adaptation of the evaluation module 50 to incorporate also an “estimation module” which can determine the critical angle of TIR, θ_{c}. This determination is achieved from measurements which will now be explained in more detail with reference to FIGS. 3 to 6.

FIG. 3 shows a biosensor configuration with a hemispherical light coupler with curved entrance window 14 and exit window 15 below the sample chamber 2. The test-light source 21 is (mechanically) scanned from an angle θ smaller than the expected critical angle θ_{c} to an angle θ_{A} that is larger than the expected critical angle θ_{c}. It is convenient to let the latter angle θ_{A} be the same angle as is used for detecting the bio-response due to the presence of target particles on the contact surface 12. The test-light detector can be scanned simultaneously with the test-light source 21. However, it is more convenient to use a sufficiently large, fixed detector 31, possibly in combination with a collimating lens 202 to collect the light.

In this configuration, the detector output S is monitored while scanning the source. At angles below the critical angle θ_{c}, the reflected intensity will be low due to partial reflection and refracted transmission. At angles equal to and larger than the critical angle θ_{c}, the intensity will be high and constant due to TIR. For a specific example of n_{A}=1.53, n_{B}=1.33, and λ=650 nm, the measured normalized detector output S* (vertical axis) is shown in the diagram of FIG. 4 in dependence on the angle of incidence θ of the test-light beam L1. From the angular position of the test-light source 21, the critical angle θ_{c}—and therefore the refractive index n_{B} of the sample liquid—can be determined.

For relevant material parameters, an example of the angles involved is shown in Table 2 of FIG. 8, i.e. for a carrier material (glass or plastic) with a refractive index n_{A}=1.53, the critical angle θ_{c} is shown for a range (between 1.3 and 1.43) of refractive indices n_{B} for a sample liquid. The data correspond to a lower angle of 58° and a final (detection) angle θ_{A} of 70°, i.e. a scan range of only 11° is sufficient to cover the whole range of practical liquids. Comparing the angles for subsequent refractive indices n_{B} shows that for detecting Δn_{B}=0.01, the required angle accuracy is very modest: a resolution of 0.7° is sufficient.

Translating the aforementioned requirements to a position results in Table 3 of FIG. 8: for a distance d of 10 mm from reflection point to test-light source or test-light detector, the beam position p (distance from carrier-liquid interface) on a plane perpendicular to the output light beam L2 (cf. FIG. 5) is shown for a range of angles θ. Using the results in Table 2, it follows that for detection of Δn=0.01, only a spatial resolution Δp* of 0.17 mm is required. Using a larger distance than 10 mm, proportionally relaxes this requirement even further.

An attractive alternative configuration is shown in FIG. 5. In this case, a relatively wide test-light beam L1 is collimated e.g. using a lens 203. The marginal rays of the collimated test-light beam, substantially focused at the investigation region 13, correspond to the minimum and maximum angles mentioned before. On the test-light detector, which can be a pixelated detector 204 such as a CCD, a light distribution similar to that of FIG. 4 will occur. This is schematically shown in FIG. 6. The position p₂ on the detector 204 corresponding to the critical angle θ_{c} is found by observing the reflected intensity S. As shown in Table 3, the required spatial resolution Δp* for detection of Δn=0.01 is only 0.17 mm.

The embodiment of FIG. 5 has the additional advantage that no mechanically moving parts are needed, which is beneficial for robustness. Moreover, the detector position p₂ can be determined relative to the edges of the illuminated cone (points p₁ and p₃). This strongly relaxes the alignment tolerances during fabrication and life-time of the product.

Returning again to FIG. 1, it can be seen that the microelectronic sensor device further realizes a third refractive index measurement unit RIMU 300 which also exploits the reflection of a test-light beam to estimate the refractive index n_{B} of the sample medium. This RIMU 300 requires:
A test-light source for emitting a test-light beam under a constant angle θ_{R} of incidence which is smaller than the critical angle θ_{c} of TIR. This test-light source may be identical to the light source 21 with an appropriate setting of the angle of incidence, and the test-light beam may accordingly be identified with the input light beam L1 (emitted however under another angle than for FTIR measurements).
A test-light detector for determining the amount of light in the test-light beam after it has been (partially) reflected at the contact interface 12 between the carrier 11 and the sample medium of interest. This test-light detector may be identical to the light detector 31 described above.
An estimation module for determining the reflectivity R of the contact surface 12 for the given angle θ_{R} of incidence and for furthermore deriving the refractive index n_{B} of the sample medium from that value. This estimation module may be integrated into the evaluation unit 50.

The RIMU 300 is based on the observation that the reflected intensity at an incident angle θ_{R} below the critical angle of TIR, θ_{c}, depends on the refractive index n_{B} of the liquid (and the carrier material). Only a single test-light beam is needed, as well as a single, fixed test-light detector 31. This detector can be, but does not need to be, the same as the one used for detecting the target particles 1.

FIG. 7 shows the reflectivity R (vertical axis) as a function of refractive index n_{B} of the sample liquid (horizontal axis), for three different combinations of refractive index n_{A} of the carrier material and the incident angle θ_{R}. As can be seen, the range of refractive indices n_{B} that can be measured reliably increases for larger refractive indices n_{A} of the carrier material. For the combination of n_{A}=1.65 and an angle θ_{R} of 50°, the range between n_{B}=1.3 and 1.38 can be measured easily: the reflectivity difference corresponding to Δn=0.01 ranges from 0.059 (around n_{B}=1.3) to 0.01 (around n_{B}=1.38). This requires a relative accuracy of only 20% to 7%. Although the range is somewhat smaller than for the previous methods, the robustness and simplicity of this method are very attractive.

It should further be noted that FIG. 1 shows a connection between the scanning mechanisms 201 associated to the light source 21 and the evaluation unit 50. Via this line, the evaluation unit 50 may adjust the angle of incidence of the input light beam L1 in such a way that variations of the refractive index n_{B} occurring from sample medium to sample medium are compensated for (e.g. with respect to the decay distance of the generated evanescent waves).

While the invention was described above with reference to particular embodiments, various modifications and extensions are possible, for example:
The microelectronic sensor device can comprise any suitable sensor to detect the presence of magnetic particles on or near to a sensor surface, based on any property of the particles, e.g. it can detect via magnetic methods, optical methods (e.g. imaging, fluorescence, chemiluminescence, absorption, scattering, surface plasmon resonance, Raman, etc.), sonic detection (e.g. surface acoustic wave, bulk acoustic wave, cantilever, quartz crystal etc), electrical detection (e.g. conduction, impedance, amperometric, redox cycling), etc.
In case an (additional) magnetic sensor is used, this can be any suitable sensor based on the detection of the magnetic properties of the particle on or near to a sensor surface, e.g. a coil, magneto-resistive sensor, magneto-restrictive sensor, Hall sensor, planar Hall sensor, flux gate sensor, SQUID, magnetic resonance sensor, etc.
In addition to molecular assays, also larger moieties can be detected with sensor devices according to the invention, e.g. cells, viruses, or fractions of cells or viruses, tissue extract, etc.
The detection can occur with or without scanning of the sensor element with respect to the sensor surface.
Measurement data can be derived as an end-point measurement, as well as by recording signals kinetically or intermittently.
The particles serving as labels can be detected directly by the sensing method. As well, the particles can be further processed prior to detection. An example of further processing is that materials are added or that the (bio)chemical or physical properties of the label are modified to facilitate detection.
The device and method can be used with several biochemical assay types, e.g. binding/unbinding assay, sandwich assay, competition assay, displacement assay, enzymatic assay, etc. It is especially suitable for DNA detection because large scale multiplexing is easily possible and different oligos can be spotted via ink-jet printing on the optical substrate.
The device and method are suited for sensor multiplexing (i.e. the parallel use of different sensors and sensor surfaces), label multiplexing (i.e. the parallel use of different types of labels) and chamber multiplexing (i.e. the parallel use of different reaction chambers).
The device and method can be used as rapid, robust, and easy to use point-of-care biosensors for small sample volumes. The reaction chamber can be a disposable item to be used with a compact reader, containing the one or more field generating means and one or more detection means. Also, the device, methods and systems of the present invention can be used in automated high-throughput testing. In this case, the reaction chamber is e.g. a well-plate or cuvette, fitting into an automated instrument.

Finally it is pointed out that in the present application the term “comprising” does not exclude other elements or steps, that “a” or “an” does not exclude a plurality, and that a single processor or other unit may fulfill the functions of several means. The invention resides in each and every novel characteristic feature and each and every combination of characteristic features. Moreover, reference signs in the claims shall not be construed as emitting their scope.

1. A microelectronic sensor device for optical examinations in a sample medium adjacent to the contact surface (12) of a carrier (11), comprising:
a) a light source (21) for emitting an input light beam (L1) into the carrier (11) such that it is totally internally reflected as an output light beam (L2) at the contact surface (12);
b) a light detector (31) for measuring a characteristic parameter of the output light beam (L2);
c) a “refractive index measurement unit”, called RIMU (100, 200, 300), for measuring the refractive index (n_{B}) of the sample medium;
d) an evaluation unit (50) for evaluating the measured characteristic parameter taking the measured refractive index (n_{B}) into account and/or for changing the conditions of total internal reflection of the input light beam (L1) according to the measured refractive index (n_{B}).

2. The microelectronic sensor device according to claim 1,
characterized in that the evaluation process of the evaluation unit (50) is based on an estimation of the decay distance of evanescent waves generated at the contact surface (12).

3. The microelectronic sensor device according to claim 1,
characterized in that the RIMU (100) comprises
a) a test-light source (101) for transmitting a test-light beam (L3) through two transparent walls (104, 105) and an intermediate test chamber (106) in which the sample medium can be provided;
b) a test-light detector (102) for detecting the spatial position (Δx) of the transmitted test-light beam (L3);
c) and optionally an estimation module (103) for estimating the refractive index (n_{B}) of the sample medium from the detected spatial position of the transmitted test-light beam.

4. The microelectronic sensor device according to claim 3,
characterized in that the two transparent walls (104, 105) have parallel sides and belong to the carrier (11).

5. The microelectronic sensor device according to claim 1,
characterized in that the RIMU (200, 300) comprises:
a) a test-light source (21) for emitting a test-light beam (L1) under a known angle of incidence onto an at least partially reflective test surface (12) which can be contacted by the sample medium;
b) a test-light detector (31) for determining the amount of light in the reflected test-light beam;
c) and optionally an estimation module (50) for estimating the refractive index (n_{B}) of the sample medium from the determined amount of light.

6. The microelectronic sensor device according to claim 5,
characterized in that the estimation module (50) is adapted to determine the critical angle (θ_{c}) of total internal reflection at the test surface.

7. The microelectronic sensor device according to claim 5,
characterized in that the estimation module (50) comprises a scanning unit (201) for varying the angle of incidence (θ) of the test-light beam (L1).

8. The microelectronic sensor device according to claim 7,
characterized in that the estimation module (50) comprises an optical system (203) for directing simultaneously a plurality of test-light beams and reflected test-light beams under different angles of incidence (θ) onto the test surface (12).

9. The microelectronic sensor device according to claim 5,
characterized in that the estimation module (50) is adapted to determine the reflectivity (R) of the test surface (12).

10. The microelectronic sensor device according to claim 1,
characterized in that the test-light detector (102, 31) comprises a plurality of sensor units.

11. A method for optical examinations in a sample medium adjacent to the contact surface (12) of a carrier (11), comprising:
a) emitting an input light beam (L1) into the carrier (11) such that it is totally internally reflected as an output light beam (L2) at the contact surface (12);
b) measuring a characteristic parameter of the output light beam (L2);
c) measuring the refractive index (n_{B}) of the sample medium;
d) evaluating the measured characteristic parameter taking the measured refractive index (n_{B}) into account and/or changing the conditions of total internal reflection of the input light beam (L1) according to the measured refractive index (n_{B}).

12. The method according to claim 11,
characterized in that a test-light beam (L3) is transmitted at an oblique angle (θₑ) through a test volume (106) of the sample medium and that the displacement (Δx) of the test-light beam after transmission is measured.

13. The method according to claim 11,
characterized in that the critical angle (θ_{c}) of total internal reflection between the sample medium and a test material (11) is determined.

14. The method according to claim 11,
characterized in that the reflectivity (R) of a test interface (12) with respect to the sample medium is measured for a given angle of incidence (θ).

15. Use of the microelectronic sensor device according claim 1 for molecular diagnostics, biological sample analysis, or chemical sample analysis.
